(19) United States
(12) Patent Application Publication
(10) Pub. No.: US 2004/0103269 A1
(43) Pub. Date: May 27, 2004

(54) Processor context register mapping

(75) Inventor: Gavin J. Stark, Fremont, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/305,836

(22) Filed: Nov. 27, 2002

(51) Int. Cl. G06F 9/44

(52) U.S. Cl. 712/228

(57) ABSTRACT

An apparatus and system may include a logical index register to be mapped onto a selected one of a plurality of physical registers, and a logical data register to be mapped onto the same selected physical register. An article, including a machine-accessible medium, may contain data capable of causing a machine to carry out a register mapping method, including mapping at least one logical index register onto a selected one of a plurality of physical registers, and mapping at least one logical data register onto the same selected physical register.

### TECHNICAL FIELD

The present invention relates generally to apparatus, systems, and methods for processing data. More particularly, the present invention relates to apparatus, systems, and methods for processing data using register operations within multiple contexts.

### BACKGROUND INFORMATION

Data processing apparatus and methods continue to increase in sophistication. Newer processors provide specialized hardware features which support processing data within multiple contexts (e.g., multi-thread processing), either serially, or simultaneously. Such features include the ability to link several processors together to solve a common problem (e.g., co-processors), as well as the provision of specific registers for maintaining state information on behalf of multiple contexts.

As the processing of a first context is interrupted in order to begin or continue processing a second context, it may be that the first and second contexts will each maintain private (local) registers, as well as shared (public) registers. Typically, data registers and index registers are kept separate within each context.

Register mapping is often used to manage the provision of shared and private registers. Register mapping is a mechanism for converting the individual data and index register numbers specified in processor instructions into physical register numbers which indicate specific physical registers to be used for executing instructions.

While the use of multiple contexts and register mapping provide a powerful combination for processing data, several drawbacks may arise. First, the separation of data and index registers makes some common operations difficult. For example, quite a few instructions may be required to perform arithmetic logic unit (ALU) operations on index registers, or to use data registers as addresses for memory transfers. Second, not all contexts require a full complement of registers; the number of registers needed during the execution of multiple contexts often varies. And finally, not all registers need to be shared, and not all registers need to remain private. Thus, there is a need for a mechanism defining which registers are private, which are shared, and how sharing between contexts will occur.

### BRIEF DESCRIPTION OF THE DRAWINGS

FIG. 1 is a block diagram of an apparatus, an article including a machine-accessible medium, and a system according to various embodiments of the invention; and

FIG. 2 is a flow diagram illustrating a method of mapping registers according to an embodiment of the invention.

### DETAILED DESCRIPTION OF EMBODIMENTS OF THE INVENTION

In the following detailed description of various embodiments of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

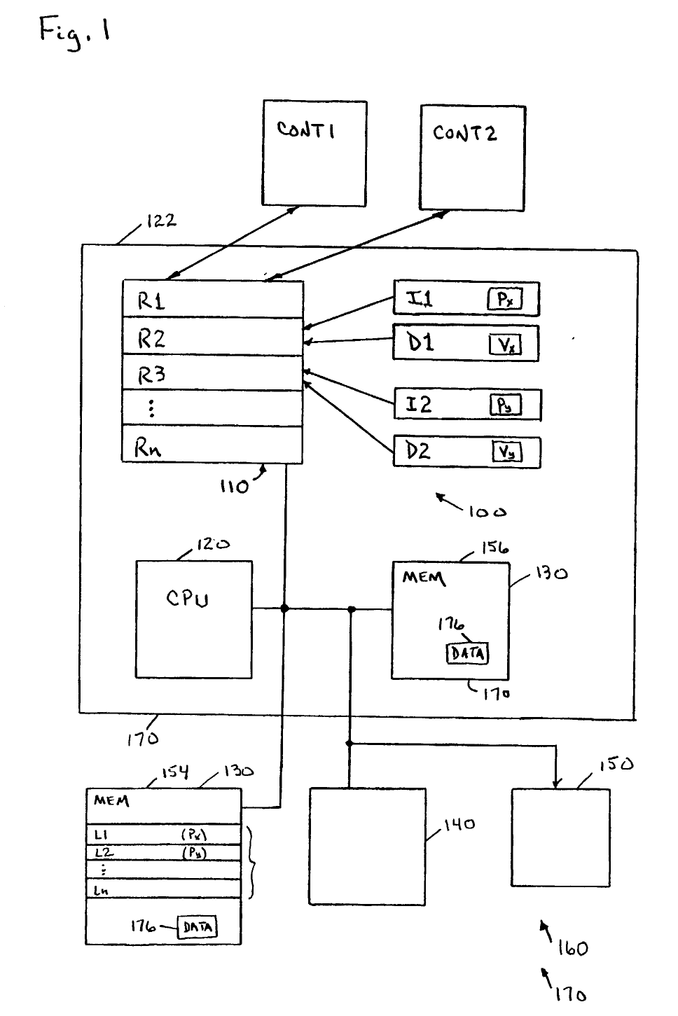

FIG. 1 is a block diagram of an apparatus, an article including a machine-accessible medium, and a system according to various embodiments of the invention. In one embodiment of the invention, an apparatus 100 for register mapping may include a logical index register (e.g., I1) and a logical data register (e.g., D1). The apparatus 100 may further include a plurality of physical registers 110. The logical index registers may be mapped onto one or more of the physical registers, as may the logical data registers. Thus, for example, the logical index register I1 may be mapped onto the physical register R2, and the logical data register D1 may be mapped onto the same physical register R2. Similarly, the logical index register I2 may be mapped onto the physical register R3, and the logical data register D2 may be mapped onto the same physical register R3.

One or more of the physical registers 110 may be communicatively coupled to a processor 120, 122, one or more memories 130, a co-processor 140, and/or a wireless transceiver 150. The processor 120, 122 may be a logic unit 120 (e.g., an arithmetic logic unit), or an integral central processing unit 122, similar to or identical to an Intel® Pentium® IV processor. The memory 130 may be an external memory capable of being communicatively coupled to, and accessed by, the processor 120, 122, or an internal memory 156 included within the processor 122. The memory technology may be, for example, dynamic random access memory, or flash memory.

In the illustrated embodiment, the order of logical register mapping may be varied. That is, a logical data register may be mapped to a selected physical register prior to mapping a logical index register to that same physical register. Conversely, a logical index register may be mapped to a selected physical register, prior to mapping a logical data register to that same physical register.

While the order of use of mapping may be changed without regard to technical feasibility (i.e., the mapping order does not affect the ability of the registers to function as such), the order in which logical registers are mapped may affect the practical outcome of the mapping operation. That is, mapping a logical index register prior to mapping a logical data register to the same physical register may have the effect of placing the value of a pointer held in the logical index register (prior to the mapping operations) into the logical data register. Similarly, mapping a logical data register to a physical register prior to mapping a logical index register to the same physical register may have the effect of placing a data value held in the logical data register (prior to the mapping operations) into the logical index register as the value of a pointer to a memory location.

Those skilled in the art will realize that each logical data register may be mapped to more than one physical register. Similarly, each logical index register may also be mapped to more than one physical register, such that any number of logical data and index registers may be mapped to any number of physical registers, in an arbitrary fashion, according to the program activity desired by the software engineer. In addition, the mapping of logical data registers and logical index registers may be changed over time, if desired.

The ability to map logical data and index registers onto one or more physical registers in this manner introduces several new opportunities for the software engineer. For example, one or more logical index registers I1, I2 and/or one or more logical data registers D1, D2 may be shared between a first context CONT1 and a second context CONT2. In this case also, the sharing arrangement may be arbitrarily specified. For example, it may also be the case that one or more logical index registers I1, I2 may not be shared between a first context CONT1 and a second context CONT2, and/or that one or more logical data registers D1, D2 may not be shared between a first context CONT1 and a second context CONT2. Other exemplary alternatives include mapping a logical index register and a logical data register onto a selected one of a plurality of physical registers in a first context, and then mapping the logical index register and/or the logical data register onto a selected other one of the plurality of physical register in a second context. Thus, the mapping of registers may be context-dependent, and change freely from context to context, over time. Many such contexts may be maintained, such that some logical registers may be shared between contexts. Mapping may also be arranged so that selected logical registers may not be shared, and are accessible solely from specified contexts.

Operations on memory pointers may also be enhanced using the disclosed inventive embodiment. Consider a memory 130 including a series of memory locations L1, L2, . . . , Ln. The memory location L1 may be associated with a pointer value Px included in the logical index register I1 (mapped to physical register R2), wherein the pointer value Px is set by loading a data value Vx (equal to the pointer value Px) into the logical data register D1, which is also mapped to the physical register R2. Conversely, a data value Vy may be loaded into the logical data register D2 (mapped to the physical register R3), setting a pointer value of Py (associated with the memory location L2) in the logical index register I2, which is also mapped to physical register R3. Thus, by mapping logical index and data registers to the same physical register, a pointer value loaded into a logical index register may be stored directly to memory simply by saving the value which appears in the correspondingly-mapped logical data register.

In another embodiment, a system 160 may comprise a processor 122 including a plurality of physical registers 110, communicatively coupled to a coprocessor 140. In the context of the system 160, at least one logical index register (e.g., I1) is capable of being mapped onto a selected one of the plurality of physical registers (e.g., R2), and at least one logical data register is capable of being mapped onto the same selected physical register (e.g., R2). The co-processor 140 may be capable of accessing the logical data registers D1, D2 and the logical index registers I1, I2 by way of being communicatively coupled to the physical registers 110. The system 160 may also include a wireless transceiver 150 capable of being communicatively coupled to the processor 120, 122.

The apparatus 100, each one of the registers 110, the processors 120, 122, the memories 130, 154, 156, the contexts CONT1, CONT2, the co-processor 140, the wireless transceiver 150, the system 160, and the registers D1, D2, I1, I2 may all be characterized as “modules” herein. Such modules may include hardware circuitry, and/or a microprocessor and/or memory circuits, software program modules, and/or firmware, and combinations thereof, as desired by the architect of the apparatus 100 and system 160, and appropriate for particular embodiments of the invention.

One of ordinary skill in the art will understand that the apparatus and systems of various embodiments of the invention can be used in applications other than for personal computers, and in applications other than for networks which include personal computers, and thus, embodiments of the invention are not to be so limited. The illustrations of an apparatus 100 and a system 160 are intended to provide a general understanding of the structure of various embodiments of the invention, and they are not intended to serve as a complete description of all the elements and features of apparatus and systems which might make use of the structures described herein.

Applications which may include the novel apparatus and systems of various embodiments of the invention include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, cellular telephones, personal computers, radios, vehicles, and others.

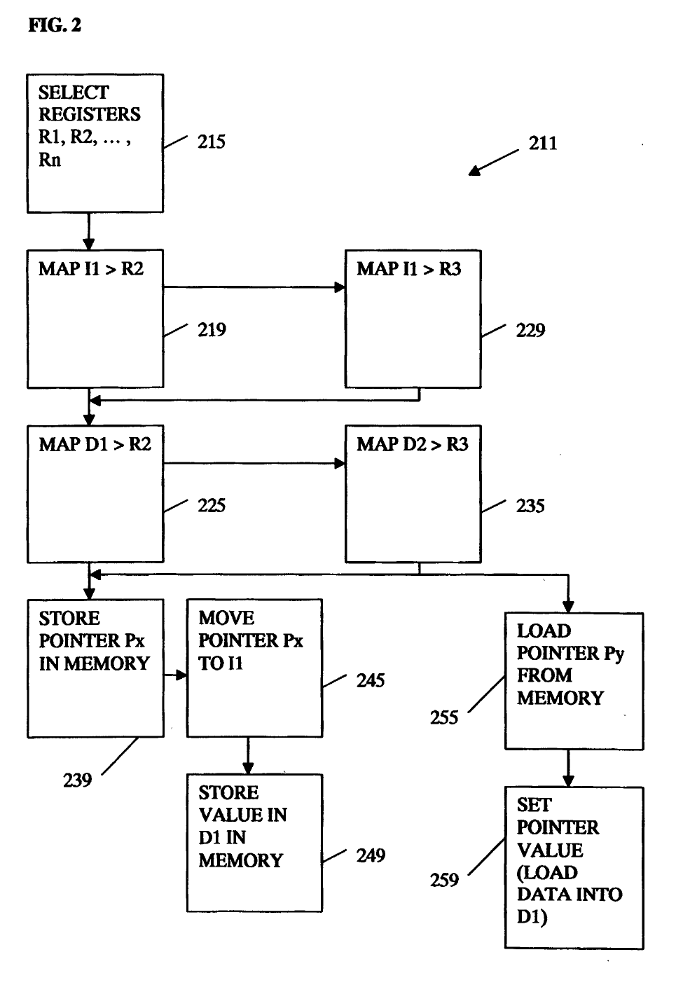

FIG. 2 is a flow diagram illustrating a method of mapping registers according to an embodiment of the invention. Referring now to FIGS. 1 and 2, it can be seen that the method 211 may begin at block 215 with selecting a plurality of physical registers. The method may continue with mapping at least one logical index register onto one or more selected physical registers, for example, such as mapping the logical index register I1 onto the physical register R2 at block 219. The method may continue with, for example, mapping at least one logical data register onto the selected physical registers, such as mapping the logical data register D1 onto the physical register R2 at block 225.

The method 211 may also continue with mapping another logical index register on to one or more selected physical registers, for example, mapping the logical index register I2 onto the physical register R3 at block 229. The method may continue with, for example, mapping another logical data register onto the selected physical registers, such as mapping the logical data register D2 onto the physical register R3 at block 235.

As noted above, the order of use of mapping logical registers onto the physical registers may affect the outcome of data/pointer movement from one logical register to another, depending on which logical register mapping follows another. Thus, if a logical index register includes a pointer value, and the logical index register is mapped onto a selected physical register, the pointer value may be transformed into a data value by subsequently mapping a logical data register to the same selected physical register. Thus, the method may include storing the pointer value directly in a memory (at block 239) by moving a pointer (e.g., Px) into a logical index register (e.g., I1) at block 245, and then storing the value held in the correspondingly-mapped logical data register (e.g., D1) in memory at block 249.

Conversely, the data value in a logical data register may be set by moving a pointer value (equal to the data value) into the correspondingly-mapped logical index register. The data value may then be stored in memory. The method also may include loading a pointer value into a logical index register (e.g., I1) directly from memory at block 255 by loading an equivalent data value into a correspondingly-mapped logical data register (e.g., D1) at block 259.

The method may also include transferring a pointer value included in a logical index register from a co-processor to a processor, for example. This can occur by loading, using the co-processor, a data value equal to the pointer value into the logical data register included in the processor (at block 259). Of course, this operation assumes the processor and co-processor both have access to and can communicate with the same physical register.

Thus, referring back to FIG. 1, it is now easily understood that another embodiment of the invention may include an article 170, such as a computer, a memory system, a magnetic or optical disk, some other storage device, and/or any type of electronic device or system, comprising a machine-accessible medium 130 (e.g., a memory including an electrical, optical, or electromagnetic conductor) having associated data 176 (e.g. computer program instructions), which when accessed, results in a machine performing such actions as mapping at least one logical index register capable of including a pointer value onto a selected one of a plurality of physical registers, and mapping at least one logical data register capable of including a data value onto the same selected physical register. The end result may be to transform the pointer value into the data value. As noted above, a second logical index register capable of including a second pointer value may also be mapped onto another selected physical register, and a second logical data register may be mapped onto the same selected physical register, also possibly resulting in the transformation of an included pointer value into a data value.

Other actions may include transferring a pointer value included in the logical index register from a co-processor to a processor, which may in turn include loading, using the co-processor, a data value equal to the pointer value into the logical data register included in the processor. The article 170 may also comprise a processor 120 and/or a wireless transceiver 150, each capable of being communicatively coupled to the machine-accessible medium 130.

Thus, several activities may accomplished with relative ease using the embodiments described herein. A first example includes sharing registers between contexts. Logical data and index registers for each context may be mapped to a selected subset of the available set of physical registers. Thus, for example, two separate contexts may exist, each sharing physical registers R2 and R3, while leaving registers R1 and Rn private.

A second example includes mapping data instructions to the same physical registers, as may occur with buffer management. Thus, if no instruction exists to directly store a pointer to memory, instead of attempting to move index registers to data registers, logical data registers may simply be mapped to the same physical registers as the logical index registers. Pointers held in the logical index registers can then be saved by storing the data values held in the correspondingly-mapped logical data registers in memory.

A final example includes dynamic register re-mapping, or “windowing”, where conventional practice depends upon using a sliding window over an infinite register set. Alternatively, for example, using some embodiments of the invention, a static window allocation may be accomplished by mapping a first subset of the available registers to be used for data gathering, and a second subset of the available physical registers as data registers to be used for data manipulation. Each task within a context can then use the mapped sets of windows without constantly loading and storing register sets from/to memory.

Although specific embodiments have been illustrated and described herein, those of ordinary skill in the art will appreciate that any arrangement that is calculated to achieve the same purpose may be substituted for the specific embodiments shown. This disclosure is intended to cover any and all adaptations or variations of various embodiments of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature of the technical disclosure. It is submitted with the understanding that it will not be used to interpret or limit the scope or meaning of the claims.

In the foregoing Detailed Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. An apparatus, comprising:
a logical index register to be mapped onto a selected one of a plurality of physical registers; and
a logical data register to be mapped onto the selected one of the plurality of physical registers.

2. The apparatus of claim 1, wherein the logical index register and the logical data register may be shared between a first context and a second context.

3. The apparatus of claim 1, wherein the plurality of physical registers may be communicatively coupled to a single processor.

4. The apparatus of claim 1, further comprising:
an other logical index register to be mapped onto a selected other one of the plurality of physical registers; and
an other logical data register to be mapped onto the selected other one of the plurality of physical registers.

5. The apparatus of claim 4, wherein the logical index register and the other logical index register may be shared between a first context and a second context.

6. The apparatus of claim 4, wherein the logical index register and the other logical index register may not be shared between a first context and a second context.

7. The apparatus of claim 4, wherein the logical data register and the other logical data register may be shared between a first context and a second context.

8. The apparatus of claim 4, wherein the logical data register and the other logical data register may not be shared between a first context and a second context.

9. The apparatus of claim 1, further comprising:
a memory including a location associated with a pointer value included in the logical index register, wherein the pointer value may be set by loading a data value equal to the pointer value into the logical data register.

10. The apparatus of claim 1, wherein the logical index register and the logical data register are mapped onto the selected one of a plurality of physical registers in a first context, and wherein the logical index register is mapped onto a selected other one of the plurality of physical registers in a second context.

11. The apparatus of claim 1, wherein the logical index register and the logical data register are mapped onto the selected one of a plurality of physical registers in a first context, and wherein the logical data register is mapped onto a selected other one of the plurality of physical registers in a second context.

12. A system, comprising:
a processor including a plurality of physical registers, wherein at least one logical index register is capable of being mapped onto a selected one of the plurality of physical registers, and wherein at least one logical data register is capable of being mapped onto the selected one of the plurality of physical registers; and
a co-processor capable of accessing the logical data register and the logical index register.

13. The system of claim 12, further comprising:
a memory having a location capable of being accessed by the processor.

14. The system of claim 13, wherein a pointer value associated with the location and included in the logical index register may be set by moving a data value equal to the pointer value into the logical data register.

15. The system of claim 13, wherein a pointer value moved into the logical index register may be stored in the location by storing a data value included in the logical data register in the location.

16. The system of claim 12, further comprising:
a wireless transceiver capable of being communicatively coupled to the processor.

17. A method, comprising:
mapping at least one logical index register onto a selected one of a plurality of physical registers; and
mapping at least one logical data register onto the selected one of the plurality of physical registers.

18. The method of claim 17, further comprising:
selecting the plurality of physical registers.

19. The method of claim 17, further comprising:
storing a pointer value included in the logical index register in a memory.

20. The method of claim 17, wherein storing the pointer value included in the logical index register in a memory further comprises:
setting a data value in the logical data register by moving the pointer value into the logical index register; and
storing the data value in the memory.

21. The method of claim 17, further comprising:
loading a pointer value from a memory into the logical index register.

22. The method of claim 21, wherein loading a pointer value from a memory into the logical index register further comprises:
setting the pointer value by moving a data value equal to the pointer value from the memory into the logical data register.

23. An article comprising a machine-accessible medium having associated data, wherein the data, when accessed, results in a machine performing:
mapping at least one logical index register capable of including a pointer value onto a selected one of a plurality of physical registers; and
mapping at least one logical data register capable of including a data value onto the selected one of the plurality of physical registers to transform the pointer value into the data value.

24. The article of claim 23, wherein the machine-accessible medium further includes data, which when accessed by the machine, results in the machine performing:
mapping a second logical index register capable of including a second pointer value onto a selected other one of the plurality of physical registers
mapping a second logical data register capable of including a second data value onto the selected other one of the plurality of physical registers to transform the second pointer value into the second data value.

25. The article of claim 23, wherein the machine-accessible medium further includes data, which when accessed by the machine, results in the machine performing:
transferring a pointer value included in the logical index register from a co-processor to a processor.

26. The article of claim 25, wherein transferring a pointer value included in the logical index register from a co-processor to a processor further comprises:
loading, using the co-processor, a data value equal to the pointer value into the logical data register included in the processor.

27. The article of claim 23, further comprising:
a wireless transceiver capable of being communicatively coupled to the machine-accessible medium.
